(19) United States
(12) Patent Application Publication
(10) Pub. No.: US 2019/0304030 A1
(43) Pub. Date: Oct. 3, 2019

(54) PROCESSING SYSTEM TO DETERMINE IMPACT OF ELECTRONIC RECORD NON-COMPLIANCE

(71) Applicant: David J. Kuethman, Wethersfield, CT (US)

(72) Inventor: David J. Kuethman, Wethersfield, CT (US)

(21) Appl. No.: 15/943,092

(22) Filed: Apr. 2, 2018

(51) Int. Cl. G06Q 40/00; G06Q 40/08; G06F 17/30

(52) U.S. Cl. CPC G06Q 40/12; G06F 17/30371; G06Q 40/08

(57) ABSTRACT

According to some embodiments, an electronic record data mart may contain electronic records representing prior transactions with an enterprise and, for each prior transaction, an electronic record identifier, an amount of resources that were allocated for the record, and a set of transaction attributes. A back-end application computer server may then automatically identify, based on transaction attributes and pre-defined compliance criteria, a set of non-complying electronic records. For each non-complying electronic record, a difference between the amount of resources that were allocated for the record and an amount of resources that would have been allocated if the record had complied with the compliance criteria may be estimated based on computer model variables. A user display may include a total difference in the amount of resources that would have been allocated for the set of non-complying electric records if each record had complied with the compliance criteria.

### BACKGROUND

An enterprise may keep electronic records associated with transactions. For example, an insurance company might keep electronic records associated with insurance claims that have been processed, including an indication of a service provider that was used to provide a service in connection with each claim (e.g., medical service, automobile repair, etc.). Moreover, the enterprise might want to analyze the electronic records to determine which records do not comply with pre-defined compliance criteria. In the case of an insurance company, certain service providers might be “preferred” as compared to other service providers (e.g., the insurance company might have agreements with preferred service provides with respect to service deadlines, invoice procedures, etc.). In this case, the insurance company might want to analyze the electronic records associated with each insurance claim to determine an impact that resulted from non-compliance (e.g., the opportunity cost that was lost due to the use of non-preferred service providers). Manually performing such an analysis, however, can be a difficult, time consuming, and error-prone task—especially when there are a substantial number of electronic records and/or pre-determined compliance criteria.

It would be desirable to provide systems and methods to automatically determine an impact of electronic record non-compliance in a way that provides faster, more accurate results and that allows for flexibility and effectiveness when responding to those results.

### SUMMARY OF THE INVENTION

According to some embodiments, systems, methods, apparatus, computer program code and means are provided to automatically determine an impact of electronic record non-compliance in a way that provides faster, more accurate results and that allow for flexibility and effectiveness when responding to those results. In some embodiments, an electronic record data mart may contain electronic records representing prior transactions with an enterprise and, for each prior transaction, an electronic record identifier, an amount of resources that were allocated for the record, and a set of transaction attributes. A back-end application computer server may then automatically identify, based on transaction attributes and pre-defined compliance criteria, a set of non-complying electronic records. For each non-complying electronic record, a difference between the amount of resources that were allocated for the record and an amount of resources that would have been allocated if the record had complied with the compliance criteria may be estimated based on computer model variables. A user display may include a total difference in the amount of resources that would have been allocated for the set of non-complying electric records if each record had complied with the compliance criteria.

Some embodiments comprise: means for accessing, by the back-end application computer server, an electronic record data mart containing electronic records representing a plurality of prior transactions with an enterprise and, for each prior transaction, an electronic record identifier, an amount of resources that were allocated for the record, and a set of transaction attributes; means for automatically identifying, based on transaction attributes and pre-defined compliance criteria, a set of non-complying electronic records; means for estimating, for each non-complying electronic record based on computer model variables, a difference between the amount of resources that were allocated for the record and an amount of resources that would have been allocated for the record if the record had complied with the compliance criteria; and means for transmitting data associated with an interactive user interface display, including a total difference in the amount of resources that would have been allocated for the set of non-complying electric records if each record had complied with the compliance criteria, via a distributed communication network.

In some embodiments, a communication device associated with a back-end application computer server exchanges information with remote devices. The information may be exchanged, for example, via public and/or proprietary communication networks.

A technical effect of some embodiments of the invention is an improved and computerized way to automatically determine an impact of electronic record non-compliance in a way that provides faster, more accurate results and that allow for flexibility and effectiveness when responding to those results. With these and other advantages and features that will become hereinafter apparent, a more complete understanding of the nature of the invention can be obtained by referring to the following detailed description and to the drawings appended hereto.

### BRIEF DESCRIPTION OF THE DRAWINGS

FIG. 1 is a high-level block diagram of a system according to some embodiments.

FIG. 2 illustrates a method according to some embodiments of the present invention.

FIGS. 3 through 6 are examples of opportunity cost interactive user displays according to some embodiments.

FIG. 7 illustrates model creation variables and output in accordance with some embodiments.

FIG. 8 is an example of a cost savings model according to some embodiments.

FIG. 9 is an example of a tiered revenue optimization model in accordance with some embodiments.

FIG. 10 is an example of a handler score card according to some embodiments.

FIG. 11 is a detailed architecture of a model creation system in accordance with some embodiments.

FIG. 12 is a block diagram of an apparatus in accordance with some embodiments of the present invention.

FIG. 13 is a portion of a tabular electronic record data mart in accordance with some embodiments.

FIG. 14 is a portion of a report output database according to some embodiments.

FIG. 15 illustrates a tablet computer displaying handler score card according to some embodiments.

FIG. 16 illustrates an overall business process flow in accordance with some embodiments.

### DETAILED DESCRIPTION

The present invention provides significant technical improvements to facilitate electronic messaging and dynamic data processing. The present invention is directed to more than merely a computer implementation of a routine or conventional activity previously known in the industry as it significantly advances the technical efficiency, access and/or accuracy of communications between devices by implementing a specific new method and system as defined herein. The present invention is a specific advancement in the area of electronic record compliance analysis by providing benefits in data accuracy, data availability and data integrity and such advances are not merely a longstanding commercial practice. The present invention provides improvement beyond a mere generic computer implementation as it involves the processing and conversion of significant amounts of data in a new beneficial manner as well as the interaction of a variety of specialized client and/or third-party systems, networks, and subsystems. For example, in the present invention information may be processed, automatically analyzed, and/or predicted via a back-end application server and results may then be reviewed accurately to evaluate the impact of non-compliance associated with past and/or future performance, thus improving the overall efficiency of the system associated with message storage requirements and/or bandwidth considerations (e.g., by reducing the number of messages that need to be transmitted via a network). Moreover, embodiments associated with predictive models might further improve customer service, predictions of future performance, allocations of resources, electronic record processing decisions, etc.

An enterprise may keep electronic records associated with transactions. For example, an insurance company might keep electronic records associated with insurance claims that have been processed, including an indication of a service provider that was used to provide a service in connection with each claim (e.g., medical service, automobile repair, etc.). Moreover, the enterprise might want to analyze the electronic records to determine which records do not comply with pre-defined compliance criteria. In the case of an insurance company, utilization of contracted vendors by a claims organization may provide a multitude of benefits including information protection, better claim outcomes, and/or an overall cost savings. Obstacles for increasing contracted vendor utilization might include a lack of accessible data, an inability to compare financial benefits in an easy and repeatable manner as well as a wide range of nuances associated with claim handling, including regulatory concerns.

Note that there may be times when a network of preferred vendors cannot meet specific needs of a claimant or claim adjuster, due to a wide range of reasons. Such reasons include scheduling conflicts, lack of specialization or expertise, regulatory stipulations and geographical limitations, etc. Utilization, or a comparison of usage between contracted and non-contracted vendors, may be an important metric for an insurance company. The methodology of counting “units” of services utilized may vary by program. For example, utilization might be calculated based on an amount of money spent on contracted vendors divided by a total spend for that program during a given time frame. Utilization may be driven by a handler's adherence to utilizing contracted suppliers, and, typically, the higher the utilization number the lower the insurance company's overall spend is in that program category.

Typical utilization reporting approaches may produce too much noise based on factoring out the appropriate non-preferred supplier spend, identifying reasons for the appropriate non-preferred supplier spend, identifying the true opportunity cost by not utilizing the contracted suppliers, including states that do not allow for the handler to influence the supplier selection, attributing the payments to the correct handler for programs where switching suppliers is difficult after initial assignment, etc.

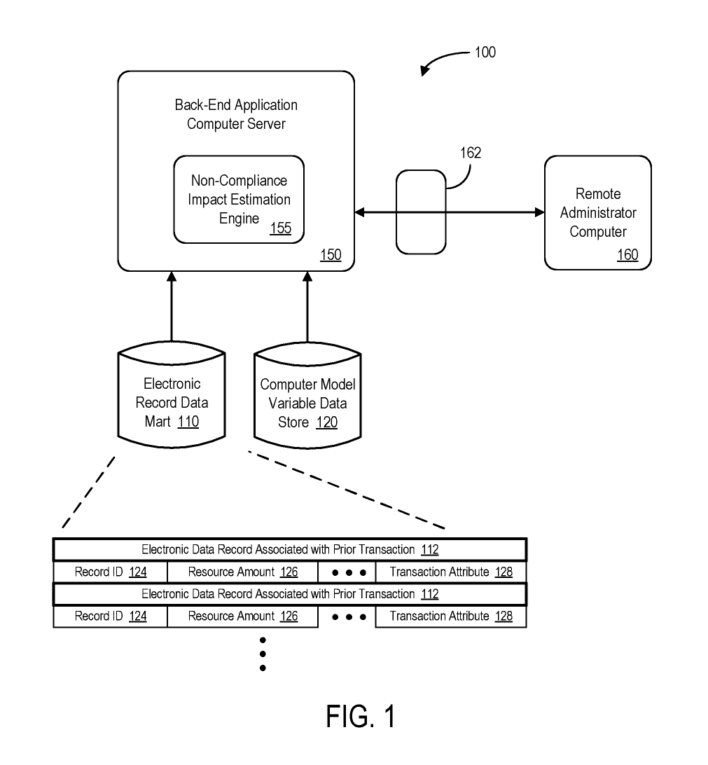

Moreover, manually performing such an analysis can be a difficult, time consuming, and error-prone task—especially when there are a substantial number of electronic records and/or pre-determined compliance criteria. It would be desirable to provide systems and methods to automatically determine an impact of electronic record non-compliance in a way that provides faster, more accurate results and that allows for flexibility and effectiveness when responding to those results. FIG. 1 is a high-level block diagram of a system 100 according to some embodiments of the present invention. In particular, the system 100 includes a back-end application computer server 150 that may access information in an electronic record data mart 110 (e.g., storing a set of electronic records 112 representing prior transactions, each record 112 including, for example, record identifiers 124, resource amounts 126, transaction attributes 128, etc.). The back-end application computer server 150 may also exchange information with a remote administrator computer 160 (e.g., via a firewall 162). According to some embodiments, non-compliance impact estimation engine 155 of the back-end application computer server 150 (and, in some cases, third-party data) may facilitate analysis, decisions, predictions, and/or the display of results via one or more remote administrator computers 160. For example, the remote administrator computer 160 may interact with the back-end application computer server 150 to create a handler score card that can be returned to the remote administrator computer 160 (after the back-end application computer server 150 may access a computer model variable data store 120 to perform the analysis). Note that the back-end application computer server 150 and/or any of the other devices and methods described herein might be associated with a third party, such as a vendor that performs a service for an enterprise.

The back-end application computer server 150 and/or the other elements of the system 100 might be, for example, associated with a Personal Computer (“PC”), laptop computer, smartphone, an enterprise server, a server farm, and/or a database or similar storage devices. According to some embodiments, an “automated” back-end application computer server 150 (and/or other elements of the system 100) may facilitate analysis of electronic records in the electronic record data mart 110. As used herein, the term “automated” may refer to, for example, actions that can be performed with little (or no) intervention by a human.

As used herein, devices, including those associated with the back-end application computer server 150 and any other device described herein may exchange information via any communication network which may be one or more of a Local Area Network (“LAN”), a Metropolitan Area Network (“MAN”), a Wide Area Network (“WAN”), a proprietary network, a Public Switched Telephone Network (“PSTN”), a Wireless Application Protocol (“WAP”) network, a Bluetooth network, a wireless LAN network, and/or an Internet Protocol (“IP”) network such as the Internet, an intranet, or an extranet. Note that any devices described herein may communicate via one or more such communication networks.

The back-end application computer server 150 may store information into and/or retrieve information from the data stores 110, 120. The electronic record data mart 110 might, for example, store electronic records representing a plurality of prior transactions, each electronic record having a set of transaction attributes. The electronic record data mart 110 may also contain information about prior and current interactions with parties, including those associated with remote communication devices. The electronic record data mart 110 may be locally stored or reside remote from the back-end application computer server 150. As will be described further below, the electronic record data mart 110 may be used by the back-end application computer server 150 in connection with an interactive user interface. Although a single back-end application computer server 150 is shown in FIG. 1, any number of such devices may be included. Moreover, various devices described herein might be combined according to embodiments of the present invention. For example, in some embodiments, the back-end application computer server 150 and the computer model variable data store 120 might be co-located and/or may comprise a single apparatus.

The system 100 may create models based on data mined from various systems. By manipulating the data with advanced calculations, the data may be used to drive complex models to determine impact of the contracted vendor and overall lost opportunities. From an end-to-end perspective, the system 100 may also deploy a reporting concept that allows insight into a particular claim adjuster's direct impact to an insurance company's performance as a result of selecting non-contracted vendors.

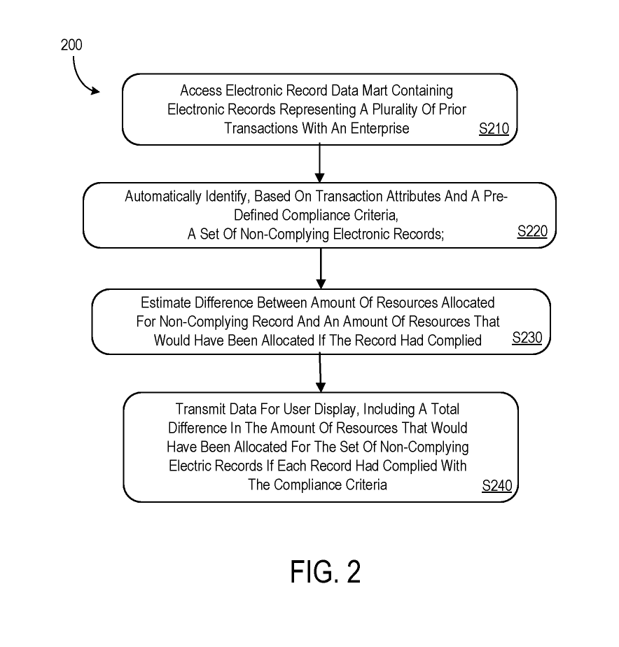

Note that the system 100 of FIG. 1 is provided only as an example, and embodiments may be associated with additional elements or components. According to some embodiments, the elements of the system 100 automatically transmit information associated with an interactive user interface display over a distributed communication network. FIG. 2 illustrates a method 200 that might be performed by some or all of the elements of the system 100 described with respect to FIG. 1, or any other system, according to some embodiments of the present invention. The flow charts described herein do not imply a fixed order to the steps, and embodiments of the present invention may be practiced in any order that is practicable. Note that any of the methods described herein may be performed by hardware, software, or any combination of these approaches. For example, a computer-readable storage medium may store thereon instructions that when executed by a machine result in performance according to any of the embodiments described herein.

At S210, a back-end application computer server may access an electronic record data mart containing electronic records representing a plurality of prior transactions with an enterprise and, for each prior transaction, an electronic record identifier, an amount of resources that were allocated for the record (e.g., an amount of money spent in connection with an insurance claim), and a set of transaction attributes (e.g., a preferred vendor status). At S220, the system may automatically identify, based on transaction attributes and pre-defined compliance criteria, a set of non-complying electronic records (e.g., insurance claims that utilized non-preferred vendors).

At S230, the system may estimate, for each non-complying electronic record based on computer model variables, a difference between the amount of resources that were allocated for the record and an amount of resources that would have been allocated for the record if the record had complied with the compliance criteria (e.g., the “opportunity cost” of not using a preferred vendor). According to some embodiments, at least some of the computer model variables are automatically calculated based on a data mined from a big data set associated with historic transactions. For example, an average resource allocation might be determined for transactions in the big data set that comply with the compliance criteria.

At S240, the system may transmit data associated with an interactive user interface display, including a total difference in the amount of resources that would have been allocated for the set of non-complying electric records if each record had complied with the compliance criteria, via a distributed communication network. According to some embodiments, at least one of the transaction attributes are associated with a transaction location, and the back-end application computer server may allow for granular-level adjustments based on location (e.g., certain states might be excluded from the analysis). In some embodiments, the interactive user interface display is associated with a resource allocation score card. The resource allocation score card might include, for example, a transaction party (e.g., a claim handler, a supervisor, a claims processing office, etc.), a transaction type, a total number of non-complying electronic records, and for each of a plurality of time periods, a difference in the amount of resources that would have been allocated for non-complying electric records if each record complied with the compliance criteria.

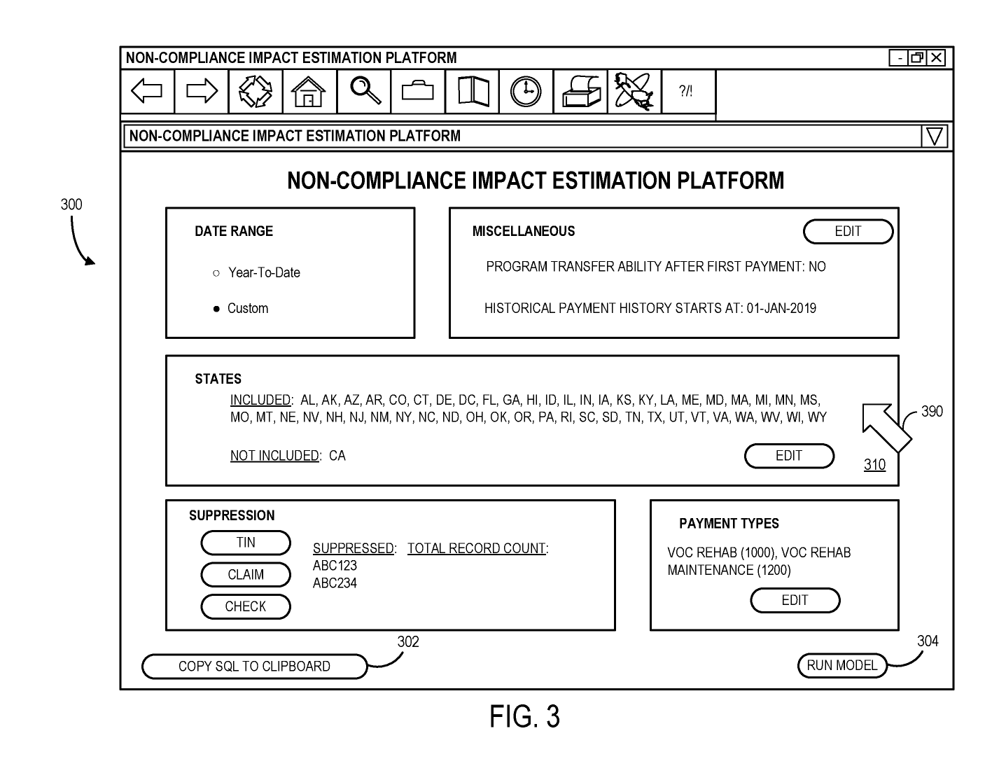

FIGS. 3 through 6 are examples of opportunity cost interactive user displays according to some embodiments. Note that a general insurance compliance impact estimation approach might neglect to factor in a myriad of state-level rules and handling guidelines. For example, an insurance company might be unable to direct services in California, but a general utilization reporting approach might aggregate at the national level (and thus a claims adjuster might be rated based on selections that are outside of his or her control. Thus, according to some embodiments, an analysis model may be designed to allow granular-level adjustments by state. Each state can be “turned-off” if an adjuster is not able to influence selection choices. For example, FIG. 3 illustrates a non-compliance impact analysis display 300 according to some embodiments. The display 300 includes options to copy information to a clipboard 302 and to run the model 304. Moreover, the display 300 includes an area 310 where states can be designated to be included (or not included) in the analysis. Note that selection of a portion of the display 300 via a touchscreen or computer mouse pointer 390 may let an operator see further details (e.g., in a pop-up window) and/or adjust various model parameters. According to some embodiments, the model can also accommodate utilization target ranges at the state level, further providing greater control and accuracy of the output.

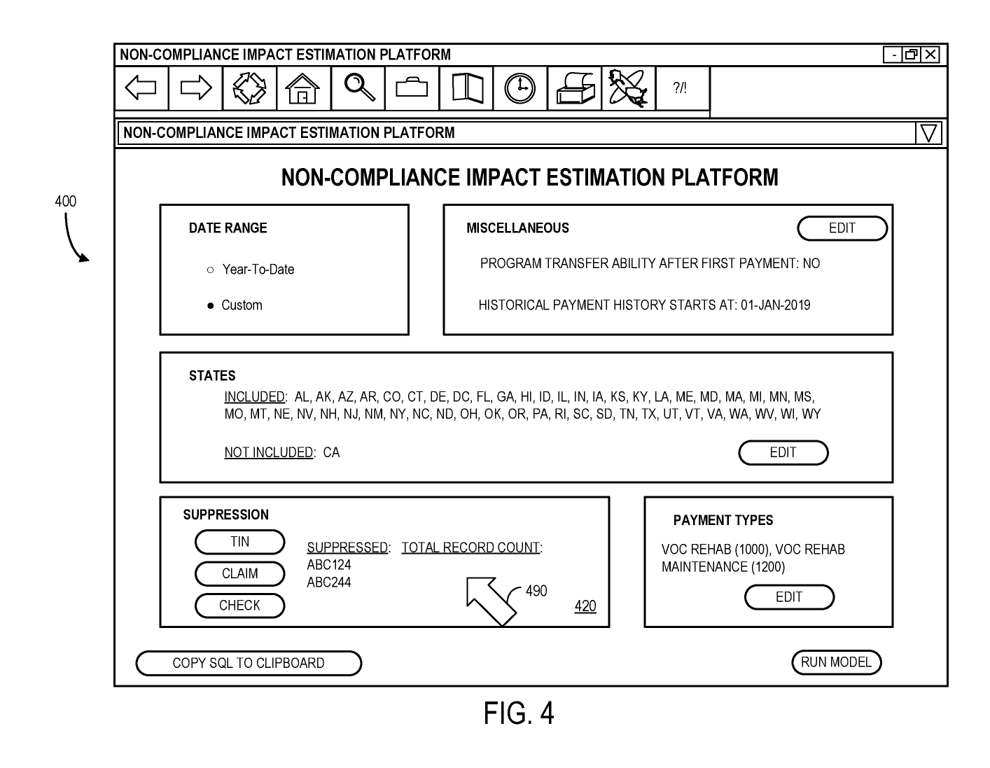

In some cases, a claim adjuster may have unique needs that can only be addressed by a non-preferred supplier. By using standard utilization reporting, a handler who received prior authorization may be incorrectly held accountable for the appropriate selection. To avoid such a result, in some embodiments at least one of the transaction attributes is associated with a transaction description, and the back-end application computer server allows for adjustments based on transaction description. For example, FIG. 4 illustrates a non-compliance impact analysis display 400 associated with electronic record suppression according to some embodiments. The display 400 includes suppression area 420 where electronic records may be excluded from analysis based on a Tax Identification Number (“TIN”), a claim identifier, a check number, etc. As before, selection of a portion of the display 400 via a touchscreen or computer mouse pointer 490 may let an operator see further details (e.g., in a pop-up window) and/or adjust various model parameters. By utilizing several variable tables, the model may suppress specific data that will not be included in the calculations, including: suppression of all payments associated to a TIN; suppression of all payments made under a specific claim number; and suppression of a specific payment by the individual check number. According to some embodiments, these choices are captured and remembered for future re-runs of the model.

Note that suppression of specific claims, suppliers and checks might lead to lost insight in terms of increasing offerings and services. In addition to capturing suppression identifiers, the system might capture the name of an approver and the reason for later reporting and analytics. Such an approach may make the model more accurate and yield greater insight into programs and identify opportunities. According to some embodiments, multiple TINs might be used by various suppliers, including discontinued ones as well as TINs that are unknown as the supplier may not be preferred, and as a result allocating appropriate TINs can be difficult when generating reports. Similar to the suppression approach, the model creator may store the TIN and associated company names and integrate the information into Structed Query Language (“SQL”) code when the model is generated. This may allow for the model to be quickly updated with new suppliers or with older TINs that may not be overlooked.

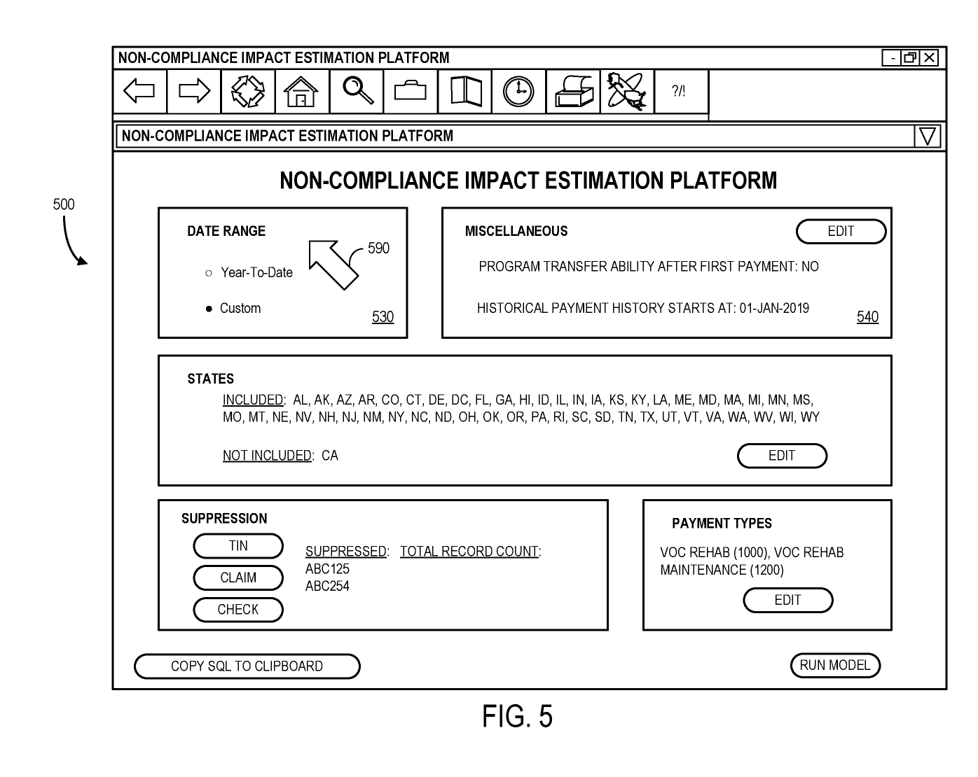

According to some embodiments, at least one of the transaction attributes is associated with a transaction date, and the back-end application computer server allows for adjustments based on a range of transaction dates. According to some embodiments, utilization and total spend reports may be generated based on fixed date ranges (e.g., year-to-date or full previous year). FIG. 5 illustrates a non-compliance impact analysis display 500 associated with flexible date ranges according to some embodiments. In particular, a date range area 530 may let an operator select (e.g., with a computer mouse pointer 590) either a year-to-date or custom date analysis. A miscellaneous area 540 may let a user select a program transfer ability after first payment and/or a start date for a historical payment history. In this way, the system may allow for quick changes to the date range so that multiple runs of the model can be achieved in very short order. Additionally, for historical data integration including responsible handler attribution, the absolute starting date can be easily modified in the miscellaneous area 540 to allow flexibility for both performance and to define appropriate parameters based on business concerns (e.g., change over of a claim system, changes in payment types, etc.).

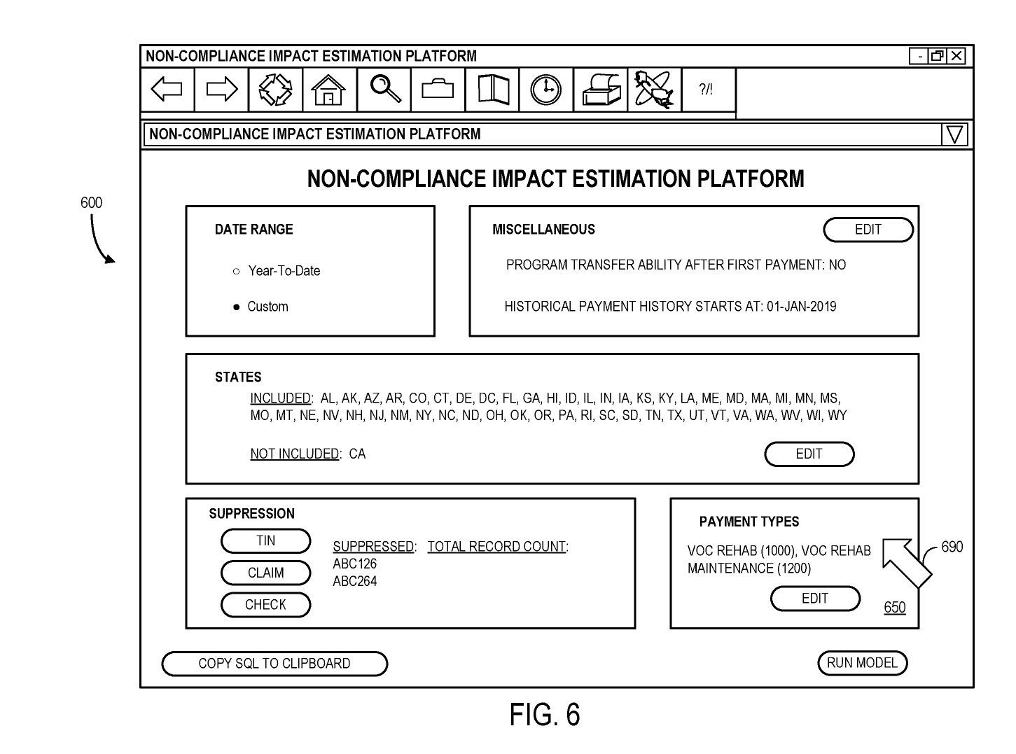

Further note that payments might be made to a vendor under different payment category types, and thus it can be difficult to aggregate payments for specific services. According to some embodiments, at least one of the transaction attributes is associated with a transaction category, and the back-end application computer server allows for adjustments based on transaction category. FIG. 6 illustrates a non-compliance impact analysis display 600 associated with a payment type area 650 (e.g., selectable via computer mouse 690) according to some embodiments. In this way, a model creator may have the ability to quickly add, delete, and/or modify multiple payment categories for inclusion in the model.

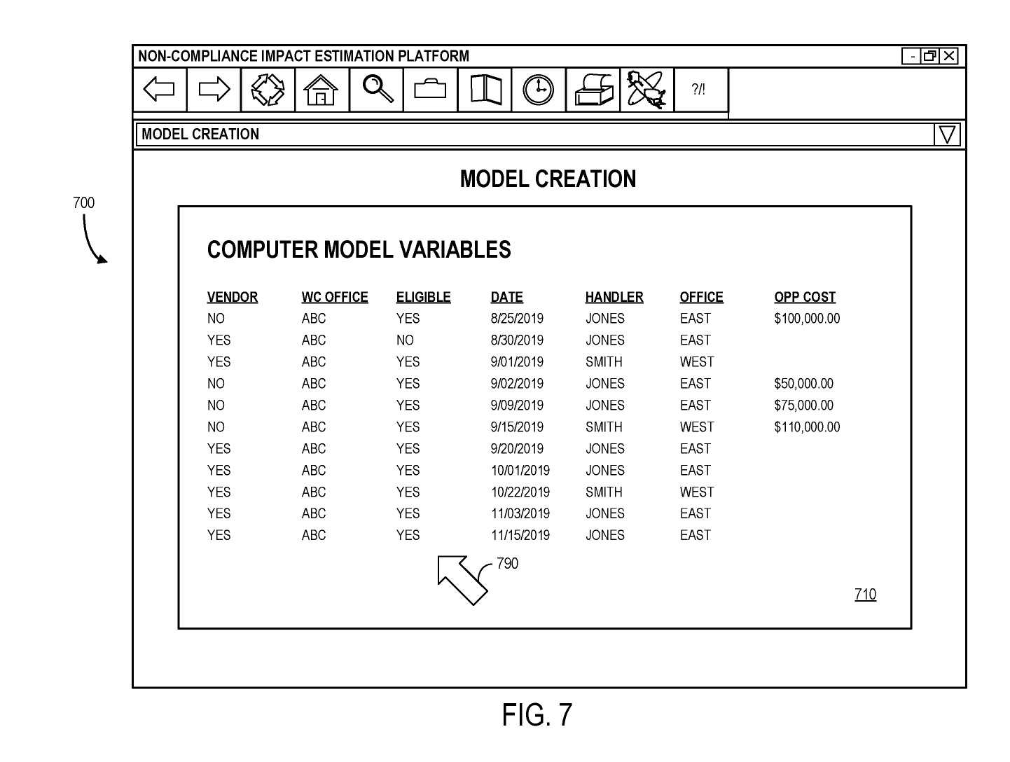

According to some embodiments, data is mined about previous usage based on unit definition. For example, a query may incorporate variables such as applicable states, suppressed TINs, suppressed check numbers, date ranges, etc. The system may then calculate an average cost for preferred vendors by state and each non-preferred vendor unit cost may be compared to the state preferred average. The system may also calculate an opportunity cost (an individual unit cost of non-contracted vendor less the contracted state average). The system may identify a responsible insurance claim handler, supervisor, and/or office based on variables and store the determined for use in models. For example, FIG. 7 illustrates a display 700 for model creation variables and output 710 in accordance with some embodiments. The variables and output 710 include a vendor preference status, an office, an eligibility indication, a date, a handler, an office, and an opportunity cost (and each might be selectable via a computer mouse pointer 790).

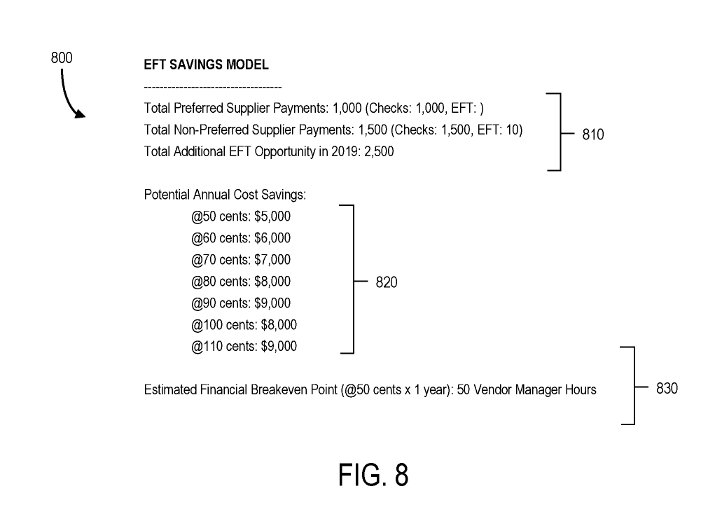

By way of example, consider FIG. 8 which is an illustration 800 of an Electronic Funds Transfer (“EFT”) cost savings model according to some embodiments. In particular, element 810 may utilize historical data from the utilization model to determine a total number of checks issued for vocational rehabilitation services along with EFT counts. Element 820 utilizes the total number of checks issued to determine cost savings at various defined savings. In this way, the model can be adapted for anticipated changes in service usage in the future. Element 830 may highlight the tool's ability to determine a “breakeven point” where the company will recover the amount spent on a vendor manager's salary while working to bring the savings program to fruition. In this example using a fictitious, fully loaded salary, the vendor manager can complete all work including negotiations, amendments, etc. within a combined 50 hours, and the insurance company will begin saving money after the first year of transitioning to Automated Clearing House (“ACH”) payments.

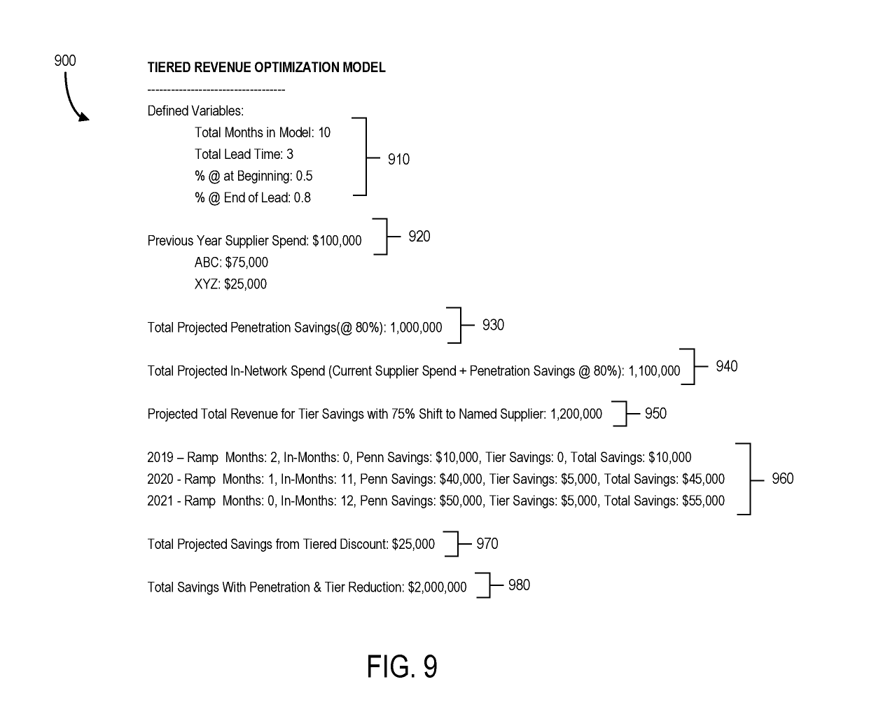

FIG. 9 is an example 900 of a tiered revenue optimization model in accordance with some embodiments. Element 910 defines variables for the model and elements 920 provide supplier spend from a historical time period by individual supplier along with aggregated information. Element 930 represents total projected utilization using a base model (inclusive of all levers) at a target utilization rate (80%). Note that the calculation may include a ramp-up period at reduced rate, and additional months between the remainder of the current year and the end of two full calendar years. Element 940 is a projection of total revenue spend, including current spend rate plus projected utilization savings at 80% target rate over the established time period. Element 950 is an amount of total projected revenue (calculated in element 940) at a 75% shift to one supplier and the remaining 25% to all other suppliers. If only there is only one supplier, the target becomes 100% automatically. Element 960 illustrates a year-over-year break out of savings by category. Element 970 is the total projected tiered revenue savings over the established time period, and element 980 includes the total of both tiered revenue and utilization savings over the established time period.

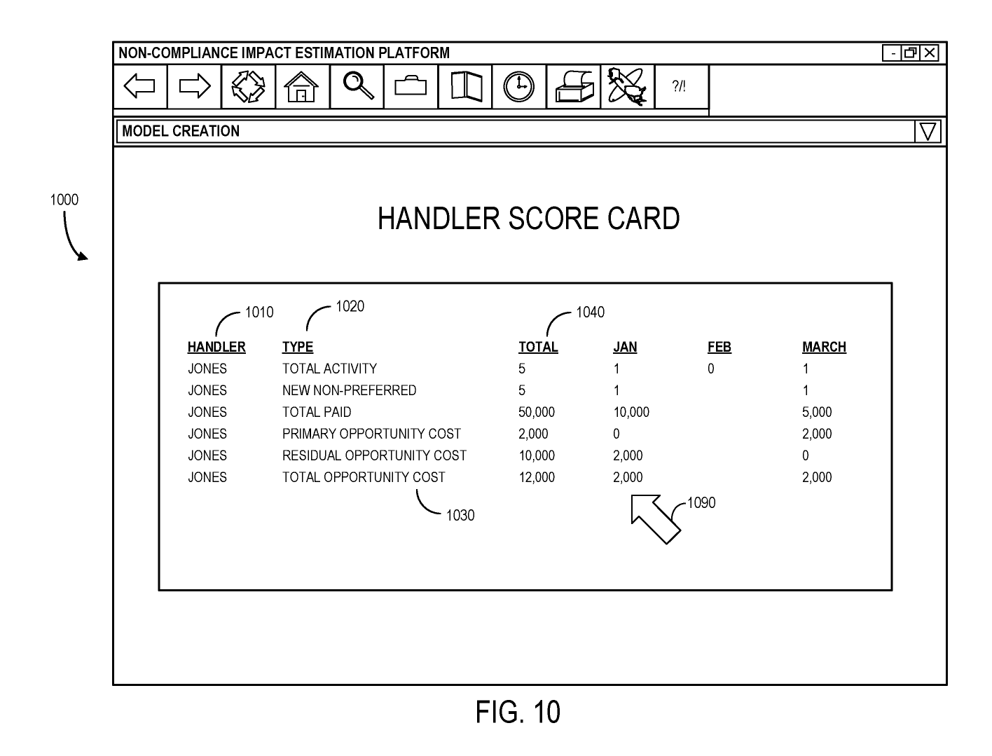

According to some embodiments, a claims handler score card may provide unique insight into a handler's overall impact to the company's financial performance. For example, FIG. 10 is an example of a handler score card display 1000 according to some embodiments. The display 1000 includes details about a handler's compliance (e.g., which may be selectable via a computer mouse pointer 1090). According to some embodiments, a “handler” identifier 1010 indicates the party ultimately responsible for the payment based on the program criteria (as opposed to someone who inherited the claim from the responsible party). That is, if the work product is one where a supplier change is not possible after assignment then total financial activity, total paid, and opportunity cost will reflect the handler who made the first assignment. Otherwise, the handler at time of payment may be considered the responsible party. The column “Type” 1020 may provide various data elements for review of the handler's adherence to the supplier program. “Total Activity” may reflect all payments made during the time period as a result of the responsible handler, while “New Non-Preferred” indicates direct assignments to vendors outside of the supplier program. “Total Paid” may represent the sum of all payments made during the time period while the handler was the owner of the file. “Primary Opportunity Cost” may be the total amount of money that could have been saved if a contracted vendor was utilized versus the non-contracted one selected by the handler 1010. Similar to “Primary Opportunity Cost,” “Residual Opportunity Cost” may be the total amount of money that could have been saved during the defined time period on files that are no longer owned by the handler 1010 where the program cannot transfer supplier assignment after initial use (essentially attributing ownership of the lost opportunity to the responsible party). “Total Opportunity Cost” 1030 may simply be the sum of “Primary and Residual Opportunity Costs” reflecting the estimated net impact, by the handler 1010, to the company's bottom by using vendors outside of the preferred network. According to some embodiments, the amounts 1040 of each data element are displayed alone with month-over-month progress to provide insight into handler 1010 performance and trending.

Note that suppressed claims, TINS, and check numbers are not included in the score card display 1000 calculations providing the ability to allow appropriate vendor selections when necessary. According to some embodiments, suppression of TINS, claims, and check numbers require documentation as to who and why the non-preferred vendor was selected. This information can be harvested for use by a vendor manager to improve network performance, influence services offered by vendors with empirical information regarding demand, and create dialogue with the claims business partners. Embodiments may also provide a roadmap of benefits to pursue based on a cost benefit analysis. The roadmap may maximize constraints and establishes goals over a set period of time. Embodiments may also provide a quick way to test savings hypothesizes without actually engaging in time-consuming pilots, and improve the speed and robustness of models giving a manager key insight during contract negotiations in almost real-time. Embodiments may also provide insight into and the ability to remedy situations with negative savings states where the average contracted rate is greater than the non-contracted costs. Note that a model creator may be designed to be utilized in any platform to capture user requirements and create robust SQL code that obtains the data and calculates the results.

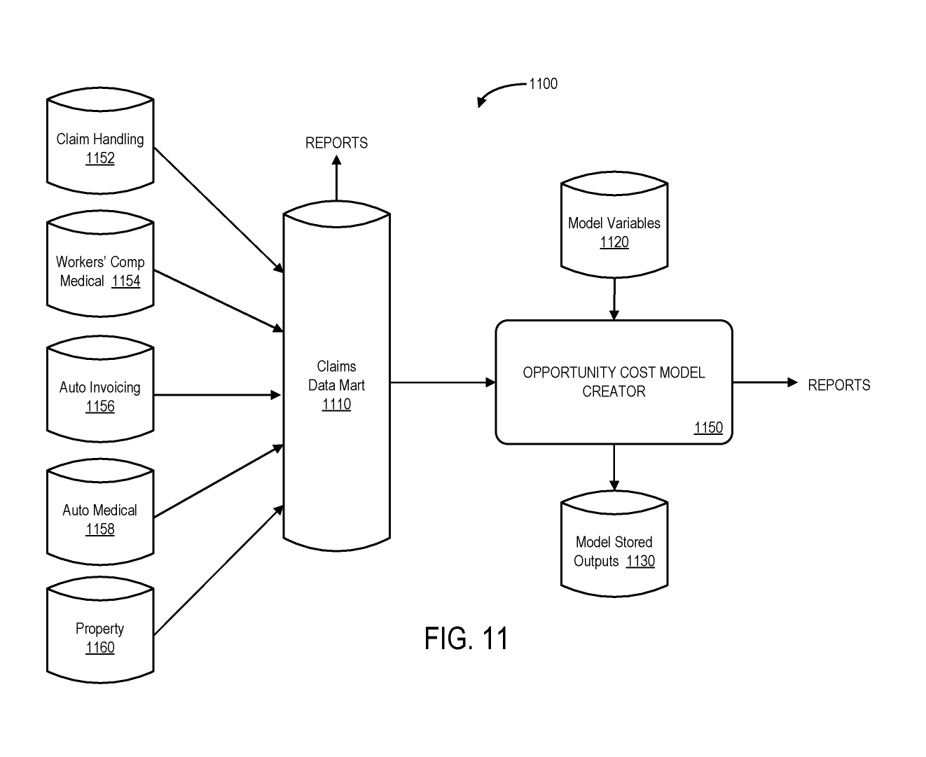

FIG. 11 is a detailed architecture of a model creation system 1100 in accordance with some embodiments. The system includes a claims data mart 1110 that contains electronic records that might originate a claim handling database 1152, a workers' compensation medical invoice database 1154, an automotive invoice database 1156, an automotive medical invoice database 1158, a property damage database 1160, etc. The claims data mart 1110 may be used to generate reports and/or to provide information to an opportunity cost model creator 1150. The opportunity cost model creator 1150 may utilize model variables 1120 to generate reports and/or information written into model stored outputs 1130.

Complex analytical functions, formulas and data processing may be handled by a database system to allow for consistent and fast execution of very large datasets spanning multiple years. The opportunity cost model creator 1150 may produce SQL code based on the stored model variables 1120. The technology for the opportunity cost model creator 1150 may be any system technology available to produce output strings from stored data. Although the system 1100 stores the variables, they may be simply added to the SQL code to create the model by using a series of materialized subquery data that persists through the query. Such embodiments may reduce the need for permanent tables. Note that the model stored outputs 1130 can be captured in any system and stored in a multitude of ways including Comma-Separated Value (“CSV”) files. According to some embodiments, the opportunity cost model creator 1150 can produce standard reports or pass-through datasets (e.g., flat and/or wide datasets) of the query results that can be pushed to multiple reporting visualization software programs, such as spreadsheet applications and the like.

Note that embodiments described herein might be associated with many different types of models, including predictive models, regression models, parametric models, non-parametric models, and/or semi-parametric models. For example, any of the models described herein might incorporate a Naive Bayes model, a k-nearest neighbor algorithm, a majority classifier, a Support Vector Machine (“SVM”), classification and regression trees, neural networks, a Generalized Linear Model (“GLM”), a logistic regression, a generalized additive model, etc.

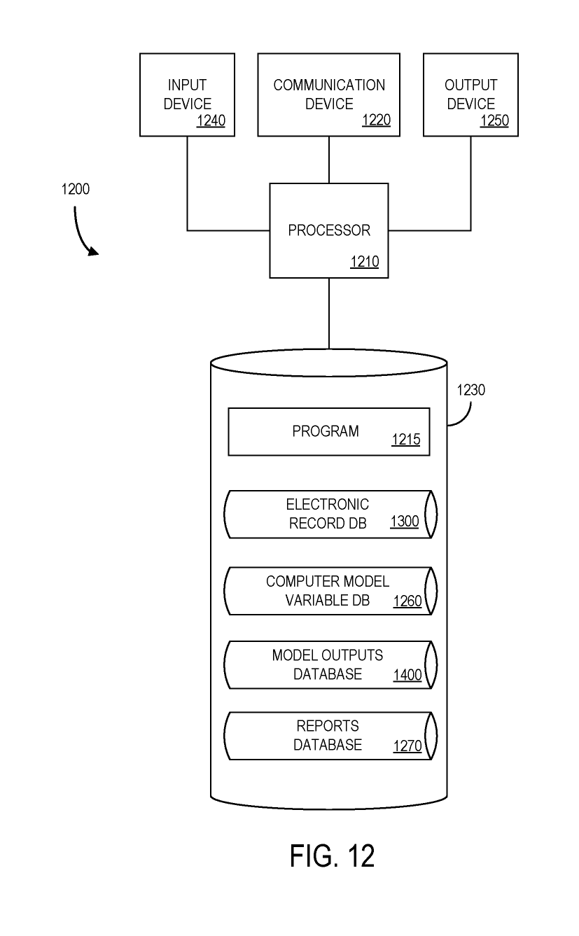

The embodiments described herein may be implemented using any number of different hardware configurations. For example, FIG. 12 illustrates an apparatus 1200 that may be, for example, associated with the systems 100, 1100 described with respect to FIGS. 1 and 11, respectively. The apparatus 1200 comprises a processor 1210, such as one or more commercially available Central Processing Units (“CPUs”) in the form of one-chip microprocessors, coupled to a communication device 1220 configured to communicate via a communication network (not shown in FIG. 12). The communication device 1220 may be used to communicate, for example, with one or more remote administrator computers and or communication devices (e.g., PCs and smartphones). Note that communications exchanged via the communication device 1220 may utilize security features, such as those between a public internet user and an internal network of the insurance enterprise. The security features might be associated with, for example, web servers, firewalls, and/or PCI infrastructure. The apparatus 1200 further includes an input device 1240 (e.g., a mouse and/or keyboard to enter information about properties, mapping data, historic information, predictive models, etc.) and an output device 1250 (e.g., to output reports regarding opportunity costs).

The processor 1210 also communicates with a storage device 1230. The storage device 1230 may comprise any appropriate information storage device, including combinations of magnetic storage devices (e.g., a hard disk drive), optical storage devices, mobile telephones, and/or semiconductor memory devices. The storage device 1230 stores a program 1215 and/or a non-compliance impact estimation tool or application for controlling the processor 1210. The processor 1210 performs instructions of the program 1215, and thereby operates in accordance with any of the embodiments described herein. For example, the processor 1210 may access an electronic record data mart that contains electronic records representing prior transactions with an enterprise and, for each prior transaction, an electronic record identifier, an amount of resources that were allocated for the record, and a set of transaction attributes. The processor 1210 may then automatically identify, based on transaction attributes and pre-defined compliance criteria, a set of non-complying electronic records. For each non-complying electronic record, a difference between the amount of resources that were allocated for the record and an amount of resources that would have been allocated if the record had complied with the compliance criteria may be estimated by the processor based on computer model variables.

The program 1215 may be stored in a compressed, uncompiled and/or encrypted format. The program 1215 may furthermore include other program elements, such as an operating system, a database management system, and/or device drivers used by the processor 1210 to interface with peripheral devices.

As used herein, information may be “received” by or “transmitted” to, for example: (i) the back-end application computer server 1200 from another device; or (ii) a software application or module within the back-end application computer server 1200 from another software application, module, or any other source.

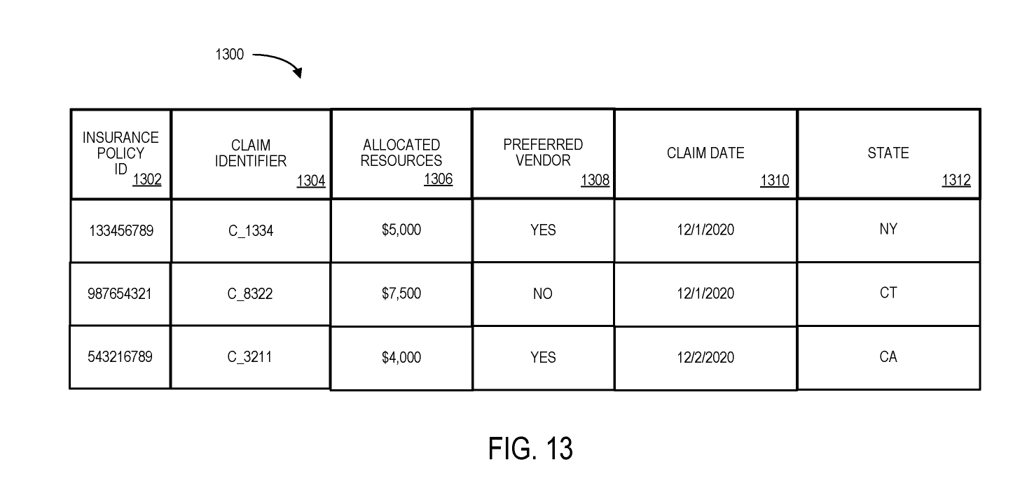

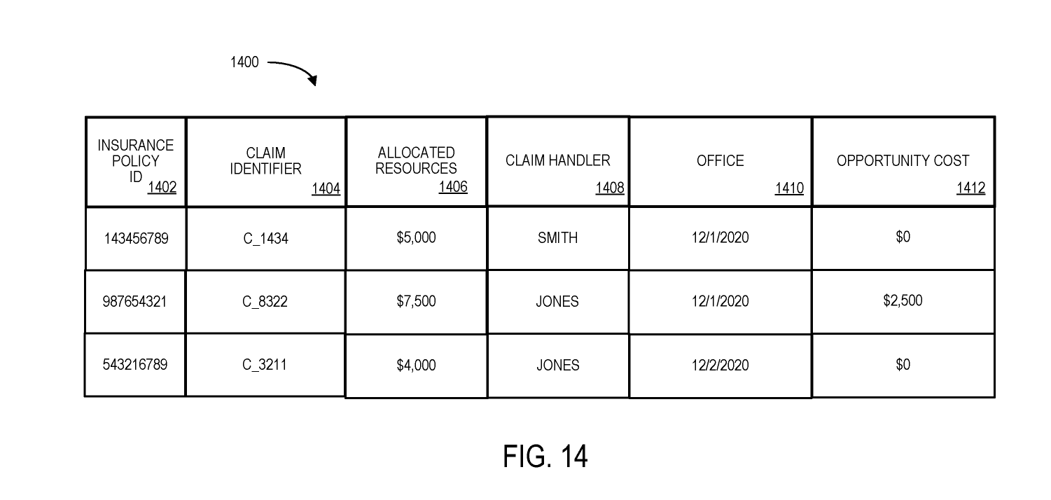

In some embodiments (such as shown in FIG. 12), the storage device 1230 further stores an electronic record database 1300, computer model variable database 1260, model outputs database 1400, and reports database 1270. Examples of databases that might be used in connection with the apparatus 1200 will now be described in detail with respect to FIGS. 13 and 14. Note that the databases described herein are only examples, and additional and/or different information may be stored therein. Moreover, various databases might be split or combined in accordance with any of the embodiments described herein. For example, the electronic record database 1300 and/or model outputs database 1400 might be combined and/or linked to each other within the program 1215.

Referring to FIG. 13, a table is shown that represents the electronic record database 1300 that may be stored at the apparatus 1200 according to some embodiments. The table may include, for example, entries associated with insurance claims being analyzed. The table may also define fields 1302, 1304, 1306, 1308, 1310, 1312 for each of the entries. The fields 1302, 1304, 1306, 1308, 1310, 1312 may, according to some embodiments, specify: an insurance policy identifier 1302, a claim identifier 1304, allocated resources 1306, a preferred vendor status 1308, a claim date 1310, and a state 1312. The electronic record database 1300 may be created and updated, for example, based on information electrically received from various computer systems, including third-party applications.

The insurance policy identifier 1302 may be, for example, a unique alphanumeric code identifying an insurance policy, and the claim identifier 1304 may represent an insurance claim (e.g., a past transaction) that is being (or has been) analyzed. The allocated resources 1306 might indication an amount of money paid to a vendor in exchange for a service, and the preferred vender 1308 might indicated whether or not the allocated resources 1306 were paid to a qualified or preferred vender. The electronic record database 1300 may further store other attributes (e.g., such as the claim date 1310, state 1312) that may be used to suppress certain records from being included in an analysis.

Referring to FIG. 14, a table is shown that represents the model outputs database 1400 that may be stored at the apparatus 1200 according to some embodiments. The table may include, for example, entries associated with insurance claims that have been analyzed by an opportunity cost model. The table may also define fields 1402, 1404, 1406, 1408, 1410, 1412 for each of the entries. The fields 1402, 1404, 1406, 1408, 1410, 1412 may, according to some embodiments, specify: an insurance policy identifier 1402, a claim identifier 1404, allocated resources 1406, claim handler 1408, an office 1410, and an opportunity cost 1412. The model outputs database 1400 might be created and/or updated based on information received from various computer systems executing an opportunity cost model.

The insurance policy identifier 1402 may be, for example, a unique alphanumeric code identifying an insurance policy and the claim identifier 1404 may represent a claim submitted under that insurance policy (and these may be based on, or associated with, the insurance policy identifier 1302 and claim identifier 1304 in the electronic record database 1300). The allocated resources 1406 may represent an amount of money paid to the service provider. The claim handler 1408 and office 1410 may be used to generate reports summarized performance. The opportunity cost 1412 may represent an estimate impact of non-compliance (e.g., the allocated resources less the average cost of a preferred provider). For example, the second entry in the table indicates that, because a non-preferred provider was used to process the claim, the amount of money spent was $2,500 more than what the average preferred service provider would have charged.

Thus, embodiments may provide an automated and efficient way to allow for the fine tuning of granular-level variables such as the ability to exclude states from the calculation. Moreover, a large number of historical data years may be used to determine the actual responsible party and attribute trending data for performance coaching. Embodiments may calculate an inclusive opportunity cost at the program and handler level and provide the ability to factor out specific payments, tax identifier numbers and entire claims from the calculations (thus acknowledging and working around the appropriate assignment of non-preferred suppliers). The system may provide the capability to track the reasons for exclusion, giving a vendor manager important information about other suppliers, claim examples and handlers to query. Embodiments may give vendor managers greater insight into how and where an enterprise should spend program dollars, key performance concerns potentially affecting the program, and a list of responsible handlers who can be addressed directly.

The following illustrates various additional embodiments of the invention. These do not constitute a definition of all possible embodiments, and those skilled in the art will understand that the present invention is applicable to many other embodiments. Further, although the following embodiments are briefly described for clarity, those skilled in the art will understand how to make any changes, if necessary, to the above-described apparatus and methods to accommodate these and other embodiments and applications.

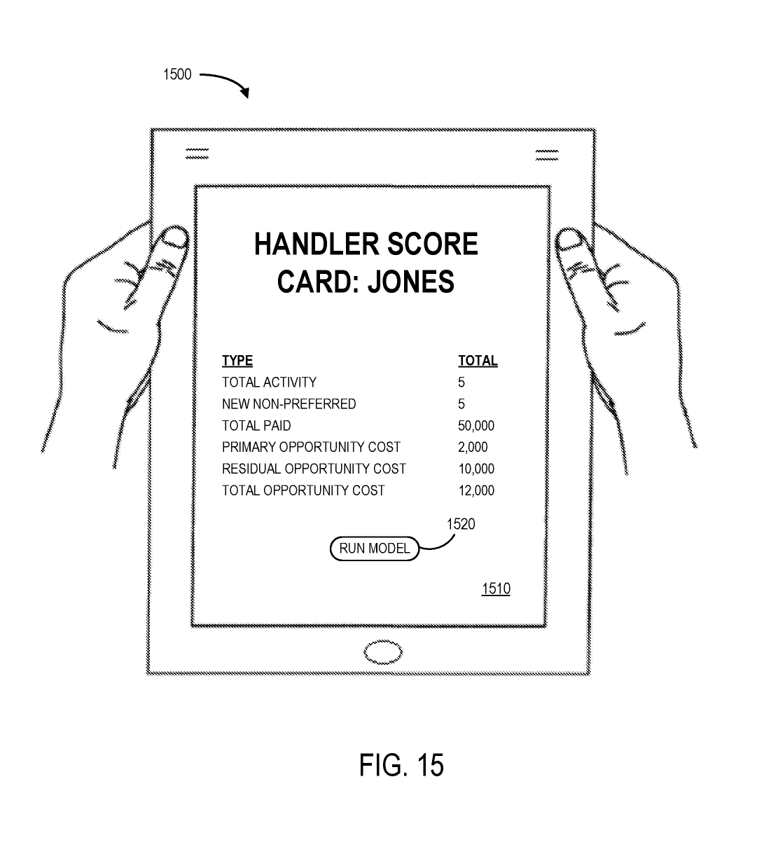

Although specific hardware and data configurations have been described herein, note that any number of other configurations may be provided in accordance with embodiments of the present invention (e.g., some of the information associated with the displays described herein might be implemented as a virtual or augmented reality display and/or the databases described herein may be combined or stored in external systems). Moreover, although embodiments have been described with respect to particular types of insurance policies, embodiments may instead be associated with other types of insurance policies in additional to and/or instead of the policies described herein (e.g., business insurance policies, automobile insurance policies, etc.). Similarly, although certain transaction attributes were described in connection some embodiments herein, other attributes might be used instead. Still further, the displays and devices illustrated herein are provided only as examples, and embodiments may be associated with any other types of user interfaces. For example, FIG. 15 illustrates a handheld tablet computer 1500 showing an insurance claim handler score card display 1510 according to some embodiments. The score card display 1510 might include user-selectable data that can be engaged and/or modified by a user of the handheld computer 1500 and icons to activate various functions 1520.

Although embodiments have been described in connection with specific lines of business, note that embodiments may be modified (e.g., the data mining approach, opportunity cost logic, applicable interfaces and models, etc.) as needed to support other lines of business and/or to create a “stock model library.” Moreover, embodiments might incorporate automated progress tracking, develop actual short-term opportunity cost reporting to compliment projected reporting, and/or leverage lessons-learned to refine the application for more robust execution tools such as the net-impact reporting. Still further, embodiments may expand the tool beyond financial benefits to more “soft” benefit impact modeling and projections. For example, embodiments may re-tool the application to mine performance data to determine an impact to customer loyalty or productivity measurements such as cycle-times. Similarly, embodiments may leverage the models to identify areas of opportunity for contracted vendors to improve overall performance and drive specific contracted vendor selections based on the unique characteristics of the claim to achieve the best possible outcomes.

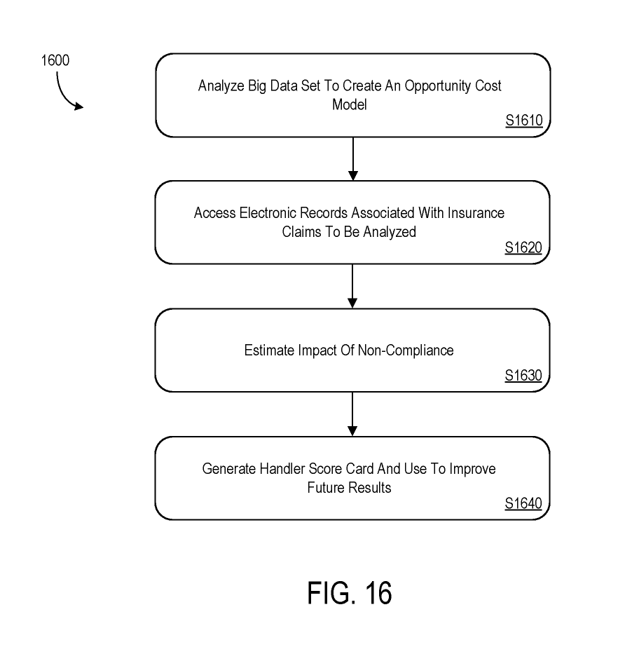

FIG. 16 illustrates an overall business process 1600 in accordance with some embodiments. At S1610, a big data set may be analyzed to automatically create an opportunity cost model (e.g., a set including years of insurance claims that have been processed by an insurance enterprise). At S1620, electronic records associated with insurance claims to be analyzed may be accessed and an estimated impact of non-compliance may be calculated at S1630. At S1640, that information may be used to create insurance handler score cards that can be used to improve future results for the enterprise (e.g., by targeting handlers for additional training).

Some embodiments described herein are directed to systems and methods to generate a claim handler score card to improve enterprise performance with respect to opportunity costs. Note, however, that the embodiments and models associated with these implementations might be used in other scenarios. For example, an administrator might alter some model parameters (e.g., an amount of savings generated when a preferred service provider is used) to determine what impact these changes will have on future performance (e.g., to run “what if” scenarios). Such a tool might be particularly useful, for example, when negotiating with service providers, making management decisions, etc.

The present invention has been described in terms of several embodiments solely for the purpose of illustration. Persons skilled in the art will recognize from this description that the invention is not limited to the embodiments described, but may be practiced with modifications and alterations limited only by the spirit and scope of the appended claims.

What is claimed:

1. A system to determine an impact of electronic record non-compliance at a back-end application computer server, comprising:
(a) an electronic record data mart containing electronic records representing a plurality of prior transactions with an enterprise and, for each prior transaction, an electronic record identifier, an amount of resources that were allocated for the record, and a set of transaction attributes;
(b) a computer model variable data store containing computer model variables;
(c) the back-end application computer server, coupled to the electronic record data mart and computer model variable data store, programmed to:
(i) access the electronic records from the electronic record data mart,
(ii) automatically identify, based on transaction attributes and pre-defined compliance criteria, a set of non-complying electronic records, and
(iii) estimate, for each non-complying electronic record based on the computer model variables, a difference between the amount of resources that were allocated for the record and an amount of resources that would have been allocated for the record if the record had complied with the compliance criteria; and
(d) a communication port coupled to the back-end application computer server to facilitate a transmission of data associated with an interactive user interface display, including a total difference in the amount of resources that would have been allocated for the set of non-complying electric records if each record had complied with the compliance criteria, via a distributed communication network.

2. The system of claim 1, wherein at least one of the transaction attributes are associated with a transaction location, and the back-end application computer server allows for granular-level adjustments based on location.

3. The system of claim 1, wherein at least one of the transaction attributes is associated with a transaction description, and the back-end application computer server allows for adjustments based on transaction description.

4. The system of claim 1, wherein at least one of the transaction attributes is associated with a transaction date, and the back-end application computer server allows for adjustments based on a range of transaction dates.

5. The system of claim 1, wherein at least one of the transaction attributes is associated with a transaction category, and the back-end application computer server allows for adjustments based on transaction category.

6. The system of claim 1, wherein at least one of the transaction attributes is associated with a transaction party, and the back-end application computer server allows for adjustments based on transaction party.

7. The system of claim 1, wherein at least some of the computer model variables are automatically calculated based on a data mined from a big data set associated with historic transactions.

8. The system of claim 7, wherein an average resource allocation is determined for transactions in the big data set that comply with the compliance criteria.

9. The system of claim 1, wherein the interactive user interface display is associated with a resource allocation score card.

10. The system of claim 9, wherein the resource allocation score card includes at least one of: (i) a transaction party, (ii) a transaction type, (iii) a total number of non-complying electronic records, and (iv) for each of a plurality of time periods, a difference in the amount of resources that would have been allocated for non-complying electric records if each record complied with the compliance criteria.

11. The system of claim 1, wherein the enterprise is an insurer, each prior transaction is an insurance claim, and the amount of resources that were allocated for the record comprise an amount of money paid in connection with the insurance claim.

12. The system of claim 11, wherein information in the electronic record data mart originates from at least one of: (i) a claim handling database, (ii) a workers' compensation medical invoice database, (iii) an automotive invoice database, (iv) an automotive medical invoice database, and (v) a property damage database.

13. A computerized method to determine an impact of electronic record non-compliance at a back-end application computer server, comprising:
accessing, by the back-end application computer server, an electronic record data mart containing electronic records representing a plurality of prior transactions with an enterprise and, for each prior transaction, an electronic record identifier, an amount of resources that were allocated for the record, and a set of transaction attributes;
automatically identifying, based on transaction attributes and pre-defined compliance criteria, a set of non-complying electronic records;
estimating, for each non-complying electronic record based on computer model variables, a difference between the amount of resources that were allocated for the record and an amount of resources that would have been allocated for the record if the record had complied with the compliance criteria; and
transmitting data associated with an interactive user interface display, including a total difference in the amount of resources that would have been allocated for the set of non-complying electric records if each record had complied with the compliance criteria, via a distributed communication network.

14. The method of claim 13, wherein at least one of the transaction attributes are associated with a transaction location, and the back-end application computer server allows for granular-level adjustments based on location.

15. The method of claim 13, wherein at least one of the transaction attributes is associated with a transaction description, and the back-end application computer server allows for adjustments based on transaction description.

16. The method of claim 13, wherein at least one of the transaction attributes is associated with a transaction date, and the back-end application computer server allows for adjustments based on a range of transaction dates.

17. The method of claim 13, wherein at least one of the transaction attributes is associated with a transaction category, and the back-end application computer server allows for adjustments based on transaction category.

18. The method of claim 13, wherein at least one of the transaction attributes is associated with a transaction party, and the back-end application computer server allows for adjustments based on transaction party.

19. A non-tangible, computer-readable medium storing instructions, that, when executed by a processor, cause the processor to perform a method to determine an impact of electronic record non-compliance at a back-end application computer server, the method comprising:
accessing, by the back-end application computer server, an electronic record data mart containing electronic records representing a plurality of prior transactions with an enterprise and, for each prior transaction, an electronic record identifier, an amount of resources that were allocated for the record, and a set of transaction attributes;
automatically identifying, based on transaction attributes and pre-defined compliance criteria, a set of non-complying electronic records;
estimating, for each non-complying electronic record based on computer model variables, a difference between the amount of resources that were allocated for the record and an amount of resources that would have been allocated for the record if the record had complied with the compliance criteria; and
transmitting data associated with an interactive user interface display, including a total difference in the amount of resources that would have been allocated for the set of non-complying electric records if each record had complied with the compliance criteria, via a distributed communication network.

20. The medium of claim 19, wherein at least some of the computer model variables are automatically calculated based on a data mined from a big data set associated with historic transactions.

21. The medium of claim 20, wherein an average resource allocation is determined for transactions in the big data set that comply with the compliance criteria.
